(19) United States
(12) Patent Application Publication
(10) Pub. No.: US 2025/0196203 A1
(43) Pub. Date: Jun. 19, 2025

(54) DEVICE AND METHOD FOR DEDUSTING TABLETS OR CAPSULES

(71) Applicant: Fette Compacting GmbH, Schwarzenbek (DE)

(72) Inventors: Frank Brachmann, Grönwohld (DE); Sven Kolbe, Büchen (DE)

(73) Assignee: Fette Compacting GmbH, Schwarzenbek (DE)

(21) Appl. No.: 18/971,666

(22) Filed: Dec. 6, 2024

(30) Foreign Application Priority Data
Dec. 18, 2023 (DE) DE102023135488.4

(51) Int. Cl. B08B 7/02; A61J 3/07; A61J 3/10; B08B 5/04

(52) U.S. Cl. CPC B08B 7/028; A61J 3/07; A61J 3/10; B08B 5/043

(57) ABSTRACT

A device for dedusting products manufactured in a production machine includes a product inlet, a product outlet, and a first surface structured to receive the products fed through the product inlet and to convey the products to the product outlet. An ultrasonic apparatus is coupled to the first surface and is structured to excite the first surface to vibrate ultrasonically. A separating apparatus is structured to feed a dust that detaches from the products due to the ultrasonic vibrations to a dust outlet of the device that is separate from the product outlet. The products are one of tablets or capsules.

### CROSS REFERENCE TO RELATED APPLICATION

This application claims the benefit and priority under 35 U.S.C. § 119 to German Patent Application No. 10 2023 135 488.4, filed on Dec. 18, 2023. The entire contents of said application is hereby incorporated by reference.

### FIELD OF TECHNOLOGY

The following disclosure relates to embodiments of a device for dedusting tablets or capsules manufactured in a production machine. In some embodiments, the device includes a product inlet and a first surface that receives tablets or capsules fed via the product inlet and that is structured to convey fed tablets or capsules to a product outlet of the device. The following disclosure is also directed to embodiments of a method for dedusting tablets or capsules manufactured in a production machine.

### BACKGROUND

Tablets or capsules manufactured in production machines, such as rotary tablet presses or capsule filling machines, often have residues of product dust on their surface after being produced. This product dust must be removed as completely as possible before further processing, in particular packaging, of the tablets or capsules. Dedusters, for example (screen-)drum dedusters, vibratory dedusters, or vertical dedusters, are known for removing powder residues adhering to tablets or capsules.

The dedusters mentioned for dedusting tablets or capsules can free tablets or capsules of adhering dust to a certain extent depending on their specific properties, their constructive design, and their functionality. However, this involves various side effects which negatively affect the tablets or capsules, the method, or the production machine, including the interfaces and peripherals thereof.

These include, for example, undesired physical influences on the tablets or capsules (stress) in the case of a drum deduster, a considerable space requirement or rather installation space in the process area in the case of a vertical deduster, a relatively low transport capacity and complexity of the cleaning due to many individual parts, for example in the case of a vertical deduster, and a significant outlay with regard to maintenance, costs, and energy demand. Moreover, other significant costs can be incurred for the media required for the dedusting process in the prior art and for the preparation of said media.

Proceeding from the explained prior art, the object of the invention is therefore to provide a device and a method of the type mentioned at the outset by means of which an undesired physical influence on the tablets or capsules is prevented, and a high dedusting capacity and a high throughput can be achieved with little outlay.

### BRIEF SUMMARY OF THE INVENTION

With regard to a device of the type mentioned at the outset, the invention achieves the object in that an ultrasonic apparatus is coupled to the first surface and excites the first surface to vibrate ultrasonically, and in that a separating apparatus is provided which feeds dust detached from the tablets or capsules on account of the ultrasonic vibrations to a dust outlet of the device that is separate from the product outlet.

With regard to a method of the type mentioned at the outset, the invention achieves the object by feeding, via a product inlet, tablets or capsules manufactured in a production machine to a first surface which conveys the tablets or capsules to a product outlet. While the tablets or capsules are being conveyed over the first surface to the product outlet, the first surface is excited to vibrate ultrasonically, such that dust is detached from the tablets or capsules on account of the ultrasonic vibrations. The dust detached from the tablets or capsules is fed to a dust outlet that is separate from the product outlet.

According to some embodiments, the tablets or capsules to be dedusted are fed to a first surface via a product inlet. The product inlet may be directly or indirectly connectable to a machine outlet of the production machine. The tablets or capsules to be dedusted are conveyed over the first surface to a product outlet of the device. During this conveying, the tablets or capsules are freed from dust particles adhering to their surface. For this purpose, an ultrasonic apparatus coupled to the first surface is provided. The first surface is excited to vibrate ultrasonically by means of the ultrasonic apparatus, which vibrations are transmitted accordingly to the tablets or capsules located on the first surface.

On account of the ultrasonic vibrations that are transmitted to the tablets or capsules, dust particles adhering to the surface of the tablets or capsules are released from the tablets or capsules. This process utilizes the fact that, on account of the ultrasonic vibrations transmitted from the first surface to the tablets or capsules, the tablets or, alternatively, capsules on the one hand and dust-like product residues on the other hand are excited to vibrate differently and thus separate from one another. In particular, the particles separated from the tablets or, alternatively, capsules due to their different geometric form and mass change their local position, for example ascend, which further drives the physical separation. Of course, other components of the device, for example wall portions, frame, other surfaces, or the like, may also be excited to vibrate ultrasonically in addition to the first surface, such that corresponding product residues can also be detached from these other components.

In some embodiments, a separating apparatus is provided which feeds dust particles detached from the tablets or capsules on account of the ultrasonic vibrations to a dust outlet that is separate from the product outlet. As a result, the tablets or capsules freed from dust arrive into the product outlet while the released dust is fed to the separate dust outlet and disposed of via same. The tablets or capsules discharged through the product outlet are effectively dedusted and can be fed for further processing, for example for inspection, coating, and/or packaging.

The invention realizes a series of advantages over the prior art. For example, on account of the device according to the invention or, alternatively, the method according to the invention, a far lesser physical influence (stress) is exerted on the tablets or capsules to be dedusted. At the same time, on account of the excitation according to the invention for causing ultrasonic vibrations and the resulting separation of the dust particles from the tablets or capsules, a significantly higher dedusting capacity is achieved, wherein even the smallest dust particles can be detached from the tablets or capsules. At the same time, the space requirement of the device according to the invention is small and the device can be positioned flexibly on or in the vicinity of a production machine or even entirely separately therefrom. The device or, alternatively, method can also be configured and enhanced in a flexible manner in order to meet different dedusting requirements. A higher throughput or rather higher transport capacity can be achieved compared with the prior art. Any undesired interaction with the overall system, which comprises a production machine, including the peripherals thereof, is minor. Simple cleaning and little assembly and disassembly effort is ensured on account of the dedusting on a surface. At the same time, the manufacturing costs are low and the energy consumption and maintenance work are reduced.

The first surface may be a surface that is closed in portions or fully closed. The first surface may be a flat surface or a curved surface, for example a cylindrical lateral surface. Suitable materials for the first surface include steels, preferably stainless steels, in particular with a view to cleanability and food safety. Plastics may also be considered as the material for the first surface.

The first surface may be enclosed by at least one frame, such that the tablets or capsules cannot fall off of the first surface and thus targeted conveying to the product outlet is ensured. The product outlet may be arranged opposite the product inlet, in particular at opposing ends of the first surface. The first surface and any other surfaces provided may be rigidly installed on the device or may be exchangeable in order to increase the flexibility with regard to different applications, in particular different tablet or capsule sizes, dust pollution, product properties (sticky products, statically charged products). The first surface and any other surfaces as well as, in principle, all components of the device may be enclosed by at least one housing, in particular in order to prevent an undesired egress of dust particles into the surroundings.

The device may also be designed as a “standalone” device. It may also be designed to be partially integrated or fully integrated in the production machine, for example in that the product inlet is directly connected to a tablet or capsule discharge of the production machine or the tablet or capsule discharge is even used as the product inlet of the device. The tablets or capsules to be dedusted may thus be fed directly or indirectly, for example via peripheral apparatuses such as vacuum conveyors, pneumatic conveyors, or the like, to the product inlet of the device. If at least one other surface is provided in addition to the first surface, the tablets or capsules conveyed over the first surface can be transferred to the at least one other surface at a transfer point. The dedusting occurs on account of the excited ultrasonic vibrations during the conveying over the first surface and any other surfaces.

According to a particularly practical embodiment, the ultrasonic apparatus may comprise an ultrasonic generator and an ultrasonic transducer connected to the ultrasonic generator, wherein the ultrasonic transducer is coupled to the first surface directly or indirectly via an ultrasonic conductor. In this embodiment, at least one ultrasonic transducer is thus coupled to the first surface. This may take place directly or indirectly via an ultrasonic conductor, for example a planar sound conductor. A planar sound conductor may be considered, in particular, if the first surface is configured in the manner of a screen or with holes, as will be explained below. The planar sound conductor is then connected at different positions to the first surface configured in the manner of a screen or provided with holes. The ultrasonic transducer transmits the ultrasonic vibrations, if applicable, via the ultrasonic conductor to the first surface and via the first surface to the tablets or capsules to be cleaned located thereon. If the first surface is delimited by a frame or housing, the frame and/or housing may be vibrationally decoupled from the ultrasonic transducer in order to prevent undesired ultrasonic interference. The ultrasonic transducer is usually connected to the ultrasonic generator, for example via corresponding lines.

As already explained, the first surface may be configured in the manner of a screen at least in portions or may be provided with a plurality of holes. Dust detached from the tablets or capsules on account of the ultrasonic vibrations then falls through screen openings or the holes in the first surface to the dust outlet, in particular into the dust outlet. The first surface may thus have a specific permeability, such that dust detached from the tablets or capsules can fall through or, alternatively, be sucked through the first surface. If the first surface is configured in the manner of a screen or with holes, different mesh widths or different hole sizes or, alternatively, hole spacings are possible depending on the application and depending on the product to be dedusted, i.e. on the tablets or capsules, in particular the size thereof. Mesh sizes or rather hole sizes of less than 5 mm, in particular less than 2 mm, more particularly less than 1 mm, are mentioned merely by way of example.

According to another embodiment, the separating apparatus may have a dust outlet opening provided upstream of the product outlet in the conveying direction of the tablets or capsules, through which dust outlet opening dust detached from the tablets or capsules on account of the ultrasonic vibrations falls to the dust outlet, in particular into the dust outlet. In this way, a physical separation of the dust from the tablets or, alternatively, capsules takes place in a particularly simple manner.

To help convey the dust away to the dust outlet, a suction apparatus may be provided which sucks dust detached from the tablets or capsules on account of the ultrasonic vibrations to the dust outlet, in particular into the dust outlet. As already explained, the suction may take place, in particular, through screen openings or holes in the first surface. The suction means may be arranged or rather act below or above the first surface and any other surfaces as well as at the sides between multiple surfaces.

According to another embodiment, the first surface may be structured at least in portions and/or comprise at least one depression and/or elevation. Fluting, roughening, or patterning are possible examples of structuring. Geometric irregularities, for example a step or groove, are possible as elevations or depressions. For example, if the first surface has a step, it may comprise multiple surface portions arranged so as to be vertically offset with respect to one another by means of a step. Whereas structuring can improve the dedusting while also facilitating deburring of tablets, geometric irregularities can be utilized to change the orientation of tablets or capsules, for example to rotate them, in order to thus dedust the surface of the tablets or capsules as completely as possible. For example, a step causes a mechanical disruption in the conveying of the tablets or capsules. As a result, release of dust particles from the surface of the tablets or capsules can be improved. For a particularly effective disruption, the step may have a height that is greater than the diameter of circular tablets or, alternatively, in the case of a different tablet shape greater than the greatest length of tablets, for example elongate tablets (oblong tablets). A height of the step of at least 5 mm, in particular more than 10 mm, is mentioned merely by way of example.

In some embodiments, the first surface may be arranged at an angle other than zero with respect to the horizontal, such that the tablets or capsules are conveyed at least partially by the force of gravity to the product outlet, in particular into the product outlet, for example entirely by the force of gravity. By means of an oblique arrangement of the first surface, the tablets or capsules as well as the released dust particles are conveyed in a desired manner over the first surface and to the relevant outlet. Even small angles of inclination of approximately 5° or less than 5° are possible for achieving the desired gravitational effect. Of course, larger angles of inclination are also conceivable. In principle, however, the angle of inclination should not be too large, in order to prevent the tablets or capsules from being conveyed too fast and thus from being dedusted incompletely. For example, it is possible for the angle of inclination to be no greater than 15°.

According to another embodiment, a second surface arranged downstream of the first surface in the conveying direction of the tablets or capsules may be provided, to which second surface the tablets or capsules are fed when same are being conveyed from the first surface, and from which second surface the tablets or capsules are conveyed further to the product outlet of the device. In this case, the tablets or capsules reach a transfer point from the first surface to a second surface. In this embodiment, the product outlet is arranged, in particular, at the end of the conveying path of the second surface or any other surfaces. The second surface may be arranged, for example, below the first surface or rather on a lower vertical level than the first surface. The tablets or capsules can then fall from the first surface onto the second surface at the transfer point. The second surface may be variably orientable, in the same way as the first surface. In this way, different directions of the flow of tablets or capsules with respect to the first surface can be realized, for example as a lengthening, in the opposite direction, by an angle, for example rotated 90°, etc. The second surface may directly adjoin the first surface. However, it is also possible for another component, for example another surface or feed component, such as a chute or the like, to be provided between the first surface and the second surface.

In principle, the second surface may also be configured in the same way as the first surface or even differently. All possible embodiments described with regard to the first surface can also be provided for the second surface or any other surfaces that are provided. Accordingly, the ultrasonic apparatus may also be coupled to the second surface and also excite the second surface to vibrate ultrasonically. In this case, further dedusting of the tablets or capsules takes place during the conveying over the second surface. If both surfaces are excited to vibrate ultrasonically, the surfaces may be excited at the same or at different frequencies.

In turn, the second surface may be configured in the manner of a screen at least in portions or with a plurality of holes, such that dust detached from the tablets or capsules on account of the ultrasonic vibrations falls through screen openings or the holes in the second surface to the dust outlet, in particular into the dust outlet, in turn through the screen openings or holes in the second surface. The related possible embodiments have been described with regard to the first surface. They may also be provided for the second surface.

In turn, it is possible for the second surface to be structured at least in portions and/or to comprise at least one depression and/or elevation. The related possible embodiments and advantages have also been described with regard to the first surface. They may accordingly be applied to the second surface.

The second surface may also be arranged at an angle other than zero with respect to the horizontal, such that the tablets or capsules are conveyed at least partially by the force of gravity to the product outlet, in particular into the product outlet, for example entirely by the force of gravity. In turn, with regard to possible embodiments and the function of such an inclination of the second surface, reference should be made to the above-mentioned embodiments of the first surface, which can also be applied to the second surface.

As already explained, the first surface and/or the second surface may comprise a step. It is also possible for a step to be provided between the first surface and the second surface. As already explained, a step of this kind causes a mechanical disruption in the conveying of the tablets or capsules. As a result, release of dust particles from the surface of the tablets or capsules can be improved. For a particularly effective disruption, the step may have a height that is greater than the diameter of circular tablets or, alternatively, in the case of a different tablet shape greater than the greatest length of tablets, for example elongate tablets (oblong tablets). In turn, a height of the step of at least 5 mm, in particular more than 10 mm, is mentioned merely by way of example.

The step may be configured such that the tablets or capsules are turned over when they are being conveyed over the step, such that they rest, for example, on the first surface or second surface by a different face after the step than before the step. According to another embodiment, the second surface may be arranged such that the tablets or capsules are turned over when they are being conveyed from the first surface to the second surface, such that they rest on the first surface by a different face than on the second surface. For example, the lower face of the tablets or capsules before the step or resting on the first surface may form the upper face after the step or on the second surface. The tablets or capsules may fall onto a lower vertical level at the step or transfer point from the first surface to the second surface. On account of the above-mentioned embodiment, the tablets or capsules can be rotated such that they then lie on the subsurface by a different face than before. As a result, particularly complete dedusting of the surface of the tablets or capsules can be achieved.

The invention also relates to a system comprising a production machine, in particular a tablet press, for example a rotary tablet press, or a capsule filling machine, having a machine outlet for tablets or capsules manufactured in the production machine, and further comprising a device according to the invention, the product inlet of which is directly or indirectly connected to the machine outlet of the product machine.

The method according to the invention can be performed with a device according to the invention. Accordingly, the device according to the invention can be designed to carry out the method according to the invention.

### BRIEF DESCRIPTION OF THE DRAWINGS

Exemplary embodiments of the invention are explained below in greater detail.

FIG. 1 schematically illustrates a side view of an embodiment of a system according to the invention.

FIG. 2 schematically illustrates a perspective view of an embodiment of a rotor or a rotary tablet press provided in the system according to the invention.

FIG. 3 schematically illustrates a sectional view of a portion of an embodiment of a dedusting device according to the invention.

FIG. 4 schematically illustrates a plan view of the embodiment of FIG. 3.

FIG. 5 schematically illustrates a sectional view of an embodiment of the dedusting device according to the invention.

FIG. 6 schematically illustrates a sectional view of another embodiment of the dedusting device according to the invention.

If not otherwise specified, the same reference numbers indicate the same objects in the figures.

### DETAILED DESCRIPTION OF THE INVENTION

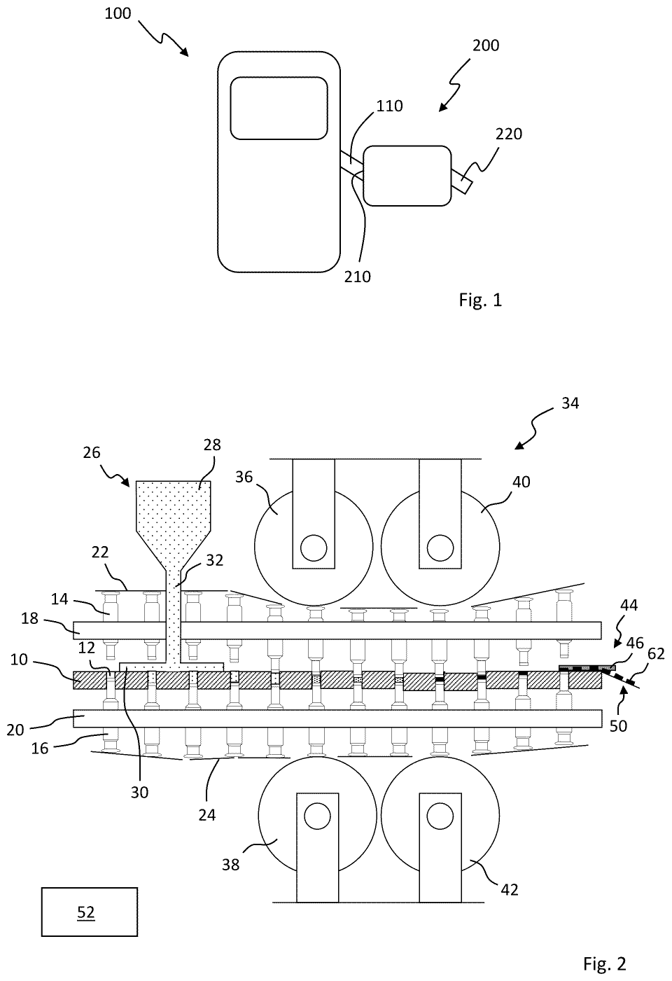

In FIG. 1, a production machine 100 is represented which may, for example, be a tablet press, in particular a rotary tablet press, or a capsule filling machine. The production machine 100 comprises a machine outlet 110 through which tablets or capsules manufactured in the production machine 100 are discharged therefrom. The machine outlet 110 is directly connected to a product inlet 210 of a device 200 according to the invention for dedusting the tablets or capsules manufactured in the production machine 100. The device 200 further comprises a product outlet 220 via which the tablets or capsules dedusted in the device 200 are dispensed and can be fed for further processing, for example for inspection, coating, and/or packaging.

In FIG. 2, a rotary tablet press is represented by way of example as a possible production machine 100. The rotary press shown in FIG. 2 is a rotary press for manufacturing tablets, in which powdered material is pressed into tablets. The rotor of the rotary press is driven in rotation by a rotary drive and comprises a die plate 10 which has a plurality of receptacles 12. The receptacles 12 can, for example, be formed by holes in the die plate 10. In addition, the rotor comprises a plurality of upper press punches 14 and lower press punches 16 which circulate synchronously with the die plate 10. The upper press punches 14 are axially guided in an upper punch guide 18, and the lower press punches 16 are axially guided in a lower punch guide 20. The axial movement of the upper press punches 14 and lower press punches 16 in the course of the rotation of the rotor is controlled by upper control cam elements 22 and lower control cam elements 24. Furthermore, a filling apparatus 26 is provided which has a filling reservoir 28 and a filling chamber 30 which are connected via a filling tube 32. In this way, in the present example, powdery material passes by the force of gravity from the filling reservoir 28 via the filling tube 32 into the filling chamber 30 and from there via a filling opening provided in the underside of the filling chamber 30, in turn by the force of gravity into the receptacles 12 of the die plate 10.

The rotary press also comprises a pressing apparatus 34. In the example shown, the pressing apparatus 34 comprises a pre-pressing apparatus with an upper compression roller 36 held on an upper holder and a lower compression roller 38 held on a lower holder, as well as a main pressing apparatus with an upper compression roller 40 held on an upper holder and a lower compression roller 42 held on a lower holder. In addition, the rotary press comprises an ejection apparatus 44 and a scraping apparatus 46 having a scraping element which feeds the tablets 48 manufactured in the rotary press to a discharge apparatus 50 for discharging from the rotary press. The scraping apparatus 46 can, for example, comprise a preferably sickle-shaped scraping element which, in the area of the ejection apparatus 44, scrapes tablets 48 conveyed onto the upper side of the die plate 10 by the lower press punches 16 from the die plate 10 and feeds them to the discharge apparatus 50. The discharge 50 leads to the machine outlet 110 of the production machine 100. Furthermore, the rotary press comprises a control apparatus 52 for controlling operation of the rotary press.

It should be noted that a capsule filling machine may be provided as the production machine 100 as an alternative to a rotary tablet press. A capsule filling machine of this kind is used to fill capsules composed of a capsule upper part and a capsule lower part and generally comprises a machine housing in which a machine table is arranged and a conveyor wheel on the periphery of which a plurality of capsule holders is provided. The capsule holders may each comprise a plurality of capsule receptacles for one capsule each. Furthermore, a conveyor wheel drive is provided by means of which the conveyor wheel can be rotated in a clocked manner, such that the capsule holders move in a clocked manner along a conveyor path. A plurality of process stations arranged at or on the machine table is provided along the conveyor path, wherein the process stations comprise at least one feed station for feeding capsules to be filled into the capsule receptacles, at least one opening station for opening the capsules to be filled by separating the capsule upper parts from the capsule lower parts, at least one filling station for filling the capsule lower parts with material to be filled, at least one closing station for closing the filled capsules by connecting the capsule upper parts to the capsule lower parts, and at least one ejection station for ejecting the filled capsules. The ejection station may, in turn, be connected to the machine outlet 110 of the promotion machine 100.

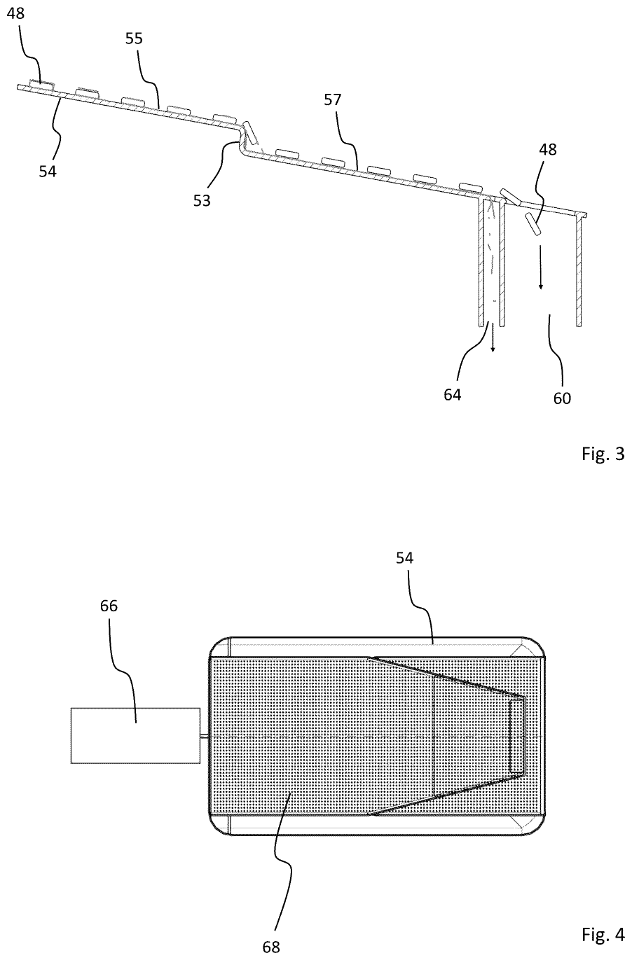

In FIG. 3, a first exemplary embodiment of a device according to the invention is partially represented. In the exemplary embodiment according to FIG. 3, the device comprises a first surface 54. In the example shown, the first surface 54 comprises two surface portions 55 and 57 that are connected to one another via a step 53 and that are each arranged at an angle other than zero, for example an angle of approximately 5°, with respect to the horizontal. On account of the step 53, the second surface portion 57 is arranged on a vertically lower level than the first surface portion 55. A product outlet 60 via which dedusted tablets 48 are discharged from the device in the example are shown is located at the end of the second surface portion 57. In the example shown, the tablets 48 fall by the force of gravity into the product outlet 60. A dust outlet 64 via which dust released from the tablets 48 is discharged separately from the tablets is located upstream of the product outlet 60 in the conveying direction of the tablets 48. The dust particles also fall by the force of gravity into the dust outlet 64.

By means of an ultrasonic apparatus (not shown in more detail in FIG. 3), the first surface 54 is excited to vibrate ultrasonically, which vibrations are transmitted accordingly to the tablets 48. In the example represented in FIG. 3, the surface portions 55, 57 may in each case be closed and flat surface portions. Dust particles are located on the surface of the tablets 48 and are detached from the tablets 48 during the ultrasonic vibrations transmitted to the tablets 48 and gather on the first surface 54. On account of the inclination of the first and second surface portions 55, 57 in conjunction with the ultrasonic excitation, the tablets 48 and the dust particles released therefrom are conveyed over the first surface 54 in the direction of the dust outlet 64 and the product outlet 60. In the region of the step 53, the tablets 48 fall by the force of gravity over a short distance from the first surface portion 55 onto the second surface portion 57, as a result of which dust particles are released better both on the upper face and on the lower face of the tablets 48. Moreover, the tablets 48 are deburred.

FIG. 4 shows an exemplary embodiment of the ultrasonic apparatus that is possible in the case of the device represented in FIG. 3. It comprises an ultrasonic generator 66 which is connected to an ultrasonic transducer 68. In the example represented in FIG. 4, the ultrasonic transducer 68 is arranged on the first surface 54, for example on the first surface portion 55, such that the ultrasonic vibration generated by the ultrasonic generator is transmitted to the first surface 54, in particular the first surface portion 55, and thus to the tablets 48. Accordingly, an ultrasonic generator may be connected via an ultrasonic transducer to the second surface portion 57.

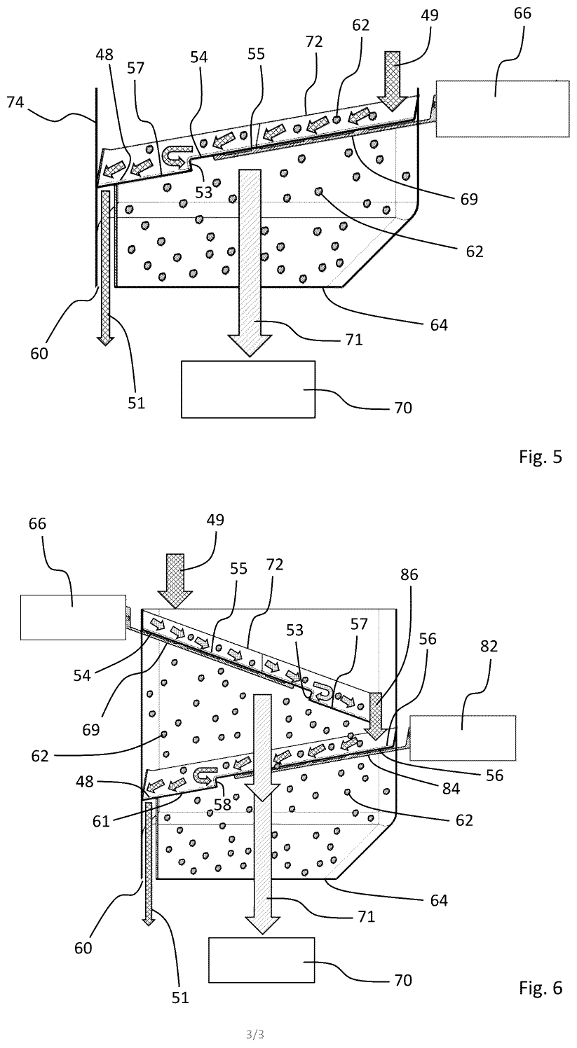

In FIG. 5, another exemplary embodiment of a device according to the invention is represented. In this exemplary embodiment, the first surface portion 55 and the second surface portion 57 are configured in the manner of a screen, such that dust particles 62 released by means of the ultrasonic apparatus from the tablets 48 fed as a tablet flow 49 fall through the screen openings in the first or, alternatively, second surface portion 55, 57 and down into a dust outlet 64. In the exemplary embodiment according to FIG. 5, a suction apparatus 70 is also provided which sucks the dust detached from the tablets 48 along a suction apparatus 71 to the dust outlet 64. Since the first surface 54 is configured in the manner of a screen in the example represented in FIG. 5, in this example the ultrasonic transducer is coupled via a planar sound conductor 69 to the first surface 54, in particular the first surface portion 55. In the exemplary embodiment according to FIG. 5, the step 53 between the first surface portion 55 and the second surface portion 57 is also designed to be so high that the tablets 48 are turned over when they fall over the step 53, such that their lower face lying on the first surface portion 55 forms the upper face on the second surface portion 57. The deburred tablets 48 freed from dust are fed to the product outlet 60 in an outlet direction 51.

In the exemplary embodiment according to FIG. 5, a frame 72 of the first surface 54 is also provided as well as a partially represented housing 74, in which all components of the device may be arranged.

In FIG. 6, another exemplary embodiment is represented which initially largely corresponds to the exemplary embodiment according to FIG. 5. In the exemplary embodiment according to FIG. 6, a second surface 56 is provided beyond the first surface 54, having a first surface portion 59 and a second surface portion 61, which are in turn connected to one another via a step 58. The second surface 56 is also arranged so as to be inclined with respect to the horizontal, for example at an angle of approximately 5°. Like the first surface 54, it is also excited to vibrate ultrasonically by means of an ultrasonic generator 82, an ultrasonic transducer, and a planar sound conductor 84. As can be identified by the arrow 86 in FIG. 6, in the example shown, tablets 48 fall by the force of gravity from the end of the first surface 54 onto the second surface 56, in particular the first surface portion 59, from which they are conveyed over the step 58 and the second surface portion 61 in turn further in the direction of the product outlet 60. The second surface 56 may be designed identically to the first surface 54 with regard to its arrangement in space. In the exemplary embodiment represented in FIG. 6, a reversal of the conveying direction of the tablets 48 takes place at the transfer point between the first surface 54 and the second surface 56. Moreover, the tablets 48 fall at the end of the second surface portion 57 of the first surface 54 by the force of gravity onto the first surface portion 59 of the second surface 56. The embodiment according to FIG. 6 can further improve the dedusting capacity and the deburring.

### LIST OF REFERENCE SIGNS

10 Die plate
12 Receptacles
14 Upper press punch
16 Lower press punch
18 Upper punch guide
20 Lower punch guide
22 Upper control cam elements
24 Lower control curve elements
26 Filling apparatus
28 Filling reservoir
30 Filling chamber
32 Filling tube
34 Pressing apparatus
36 Upper pressing roller
38 Lower pressing roller
40 Upper pressing roller
42 Lower pressing roller
44 Ejection apparatus
46 Scraping apparatus
48 Tablets/capsules
49 Tablet flow
50 Discharge apparatus
51 Outlet direction
52 Control apparatus
53 Step
54 First surface
55 First surface portion of the first surface
56 Second surface
57 Second surface portion of the first surface
58 Step
59 First surface portion of the second surface
60 Product outlet
61 Second surface portion of the second surface
62 Dust particles
64 Dust outlet
66 Ultrasonic generator
68 Ultrasonic transducer
69 Planar sound conductor
70 Suction apparatus
71 Suction direction
72 Frame
74 Housing
76 Third surface
78 Fourth surface
80 Step
82 Ultrasonic generator
84 Planar sound conductor
86 Arrow
100 Production machine
110 Machine outlet
210 Product inlet
200 Device
220 Product outlet

1. A device for dedusting products manufactured in a production machine, comprising:
a product inlet;
a product outlet;
a first surface configured to receive the products fed through the product inlet and to convey the products to the product outlet;
an ultrasonic apparatus coupled to the first surface and configured to excite the first surface to vibrate ultrasonically; and
a separating apparatus configured to feed a dust detached from the products due to the ultrasonic vibrations to a dust outlet of the device that is separate from the product outlet,
wherein the products are one of tablets or capsules.

2. The device according to claim 1, wherein the ultrasonic apparatus comprises an ultrasonic generator and an ultrasonic transducer connected to the ultrasonic generator, wherein the ultrasonic transducer is operatively coupled to the first surface directly via an ultrasonic conductor.

3. The device according to claim 1, wherein the first surface comprises a plurality of openings, and wherein such the dust detached from the products on account of the ultrasonic vibrations falls through the plurality of openings in the first surface and into the dust outlet.

4. The device according to claim 1, wherein the separating apparatus comprises the dust outlet opening positioned upstream of the product outlet in a conveying direction of the products, and wherein dust detached from the products on account of the ultrasonic vibrations falls into the dust outlet.

5. The device according to claim 1, further comprising a suction apparatus configured to suck the dust detached from the products to the dust outlet.

6. The device according to claim 1, wherein the first surface comprises at least one of: (1) one or more depressions; (2) one or more portions; and (3) one or more elevations.

7. The device according to claim 1, wherein the first surface is arranged at an angle with respect to a horizontal axis, such that the products are conveyed at least partially by a force of gravity to the product outlet, wherein the angle is other than zero degrees.

8. The device according to claim 1, further comprising a second surface arranged downstream of the first surface in a conveying direction of the products, wherein the products are fed to the second surface from the first surface, and wherein the products are conveyed from the second surface to the product outlet of the device.

9. The device according to claim 8, wherein the ultrasonic apparatus is also operationally coupled to the second surface and configured to excite the second surface to vibrate ultrasonically.

10. The device according to claim 9, wherein the second surface comprises a plurality of openings, and wherein the dust detached from the products on account of the ultrasonic vibrations falls through the plurality of openings in the second surface and into the dust outlet.

11. The device according to claim 8, wherein the second surface comprises at least one of: (1) one or more depressions; (2) one or more portions; and (3) one or more elevations.

12. The device according to claim 8, wherein the second surface is arranged at an angle with respect to a horizontal axis, wherein the products are conveyed at least partially by a force of gravity to the product outlet, and wherein the angle is other than zero degrees.

13. The device according to claim 8, wherein at least one of the first surface and the second surface comprises a step.

14. The device according to claim 8, further comprising a step separating the first surface from the second surface.

15. The device according to claim 14, wherein the step comprises a height dimension that is greater than at least one of: (1) a diameter of the products; and (2) a length of the products.

16. The device according to claim 15, wherein the step is configured to turn the products over when the products are being conveyed over the step, and wherein the products rest on a different product face after traveling over the step than before traveling over the step.

17. The device according to claim 8, wherein the second surface is arranged such that the products are turned over as the products are conveyed from the first surface to the second surface, and wherein the products rest on a different face when the products are on the first surface than when the products are on the second surface.

18. A system comprising:
the production machine configured to produce the products and comprising a machine outlet configured to output the products from the production machine;
the device according to claim 1,
wherein the product inlet of the device is connected to the machine outlet of the production machine, and
wherein the production machine comprises one of (1) a tablet press; or (2) a capsule filling machine.

19. A method for dedusting products manufactured in a production machine, comprising:
feeding the products manufactured in the production machine through a product inlet and onto a first surface;
conveying the products along the first surface to a product outlet;
ultrasonically vibrating the first surface while conveying the products to detach dust from the products;
conducting the dust detached from the products to a dust outlet that is separate from the product outlet,
wherein the products comprise one of: (1) tablets; and (2) capsules.
